(19) United States
(12) Patent Application Publication
(10) Pub. No.: US 2006/0167764 A1
(43) Pub. Date: Jul. 27, 2006

(54) Process of downloading data

(75) Inventor: Jean Stellittano, Arpajon (FR)

Correspondence Address: Martin Faier;Faier & Faier, P.C., Suite 600, 566 W. Adams St., Chicago, IL, 60661, US

(73) Assignee: Societe ALPARFI, Paris (FR)

(21) Appl. No.: 11/326,772

(22) Filed: Jan. 6, 2006

(30) Foreign Application Priority Data
Jan. 7, 2005 (FR) 05 00187

(51) Int. Cl. G06Q 30/00

(52) U.S. Cl. 705/26

(57) ABSTRACT

This invention relates to a process for downloading data from Internet onto a data storage support from a downloading terminal, characterized in that said data are downloaded directly by connection of said support on said terminal, located in a public place, the process comprising the exchange of data between at least one downloading terminal, a proxy server and a payment server. More precisely, the process comprises the steps of: Selection of the data to be downloaded, Validation of the customer's selection, Selection of the support for downloading and/or its model, Insertion of the downloading support and connection of the downloading support with the terminal, Detection of the downloading support by the terminal, Payment of the downloaded data by the customer, Transfer of the data towards the downloading support.

### FIELD OF THE INVENTION

The present invention relates to a process for downloading data from a downloading terminal.

### BACKGROUND OF THE INVENTION

Processes for downloading data from a computer interface are known and make it possible, in particular, to choose and consult in advance works that the user wishes to download, to seek additional information on that work and to pay for the downloading in secure manner.

According to the prior art, it is known to be able to download data, for example musical titles or compositions, from a user interface by connecting onto Internet via a personal computer at home.

It is then necessary to go onto an Internet site allowing such downloading, to pay by giving one's bank card number, then to store the downloaded data, generally on one's hard disk.

Moreover, such processes of downloading are based on the operation of an Internet site and the titles are downloaded exclusively onto the personal computer or onto internal memory peripherals, for example the hard disc of the computer in the majority of cases.

It would be advantageous to produce devices allowing downloading of intellectual work, particularly musical titles, without the incidentals associated with the equipment necessary for allowing such downloading, in particular due to the dimensions of such equipment.

It would therefore be of interest to produce a sufficiently versatile device to allow downloading onto any type of support.

Secured downloading means must likewise be produced, in order to prevent and repair dishonest or accidental operations by users in the data-processing system of the downloading means.

It is an object of the present invention to propose solving this problem with the aid of a process of downloading which is simple, secure, easy to manipulate and set, from a downloading terminal.

### SUMMARY OF THE INVENTION

To that end, the present invention relates to a process for downloading data from a downloading terminal, comprising the step of downloading data from said terminal located in a public place and comprising exchanges of data between at least one downloading terminal, a proxy server and a payment server.

The process advantageously comprises the following steps:
Selection of the data to be downloaded,
Validation of the customer's selection,
Selection of the support for downloading and/or its model,
Insertion of the downloading support and connection of the downloading support with the terminal,
Detection of the downloading support by the terminal,
Payment of the downloaded data by the customer,
Transfer of the data towards the downloading support.

More precisely and advantageously, the downloaded data are musical titles or compositions and the downloading support is a USB (Registered Trademark) card or key, a device of the PDA type, a laptop computer, a personal digital stereo or a memory card and other peripherals.

The process is advantageously implemented from a proxy server comprising a payment server, a data-storage server, a server for managing the licences associated with the data, an e-mail managing server and an http server and an FTP server.

The downloaded data are paid for either with a bank card or with a prepaid card.

In order to protect the downloaded data, a Digital Right Management (DRM) module is associated with the operating system of the terminal, the DRM module being adapted to download said data from said storage server onto said proxy server and the licenses from said licence managing server.

In order to secure the exchanges of data, the data exchanges are carried out by means of a secure connection of the Virtual Private Network (VPN) type.

### BRIEF DESCRIPTION OF THE DRAWINGS

The invention will be more clearly understood on reading the following description given by way of illustrative and non-limiting example, with reference to the accompanying drawings, in which:

FIG. 1 schematically shows the terminal according to the invention and the different physical elements interacting therewith.

FIG. 2 schematically shows the steps of the process of downloading according to the invention.

### DESCRIPTION OF PREFERRED EMBODIMENT

Referring now to the drawings, the process according to the present invention comprises downloading means 1 in the form of a downloading terminal 2.

The downloading terminal 2 is advantageously composed of a central unit of PC type with a processor of Intel Pentium 4 (Registered Trademark) type.

However, the central unit of the terminal 2 according to the invention is capable of functioning with any type of processor.

Moreover, a 12″ or 15″ touch screen is connected to the central unit.

Nonetheless it may be envisaged to connect the central unit to a non-touch screen of type known per se, with keyboard and mouse.

In order to allow the users of the terminal 2 to connect onto Internet and to store the downloaded data, the terminal 2 comprises means for connection to a downloading support in the form of a memory card reader hub compatible in particular with the SmartMedia (SD) (Registered Trademark), MultimediaMemoryCard (MMC) (Registered Trademark), CompactFlash (Registered Trademark), MemoryCard (Registered Trademark) and MemoryStick (Registered Trademark) format.

There are also provided on the terminal 2 two USB ports, IE 1394 ports, one infrared port, one Bluetooth (Registered Trademark) port, one LAN 100 mbs network card, one wireless wi-fi (Registered Trademark) network card and one magnetic card reader. It should be noted that the LAN card does not intervene in the connection of the peripherals, but solely in the access to the network.

It is also provided to connect the terminal 2 to payment means, for example in the form of a bank card and prepaid smart card reader box equipped with a digital keyboard, such equipment all being of type known per se and currently available on the market.

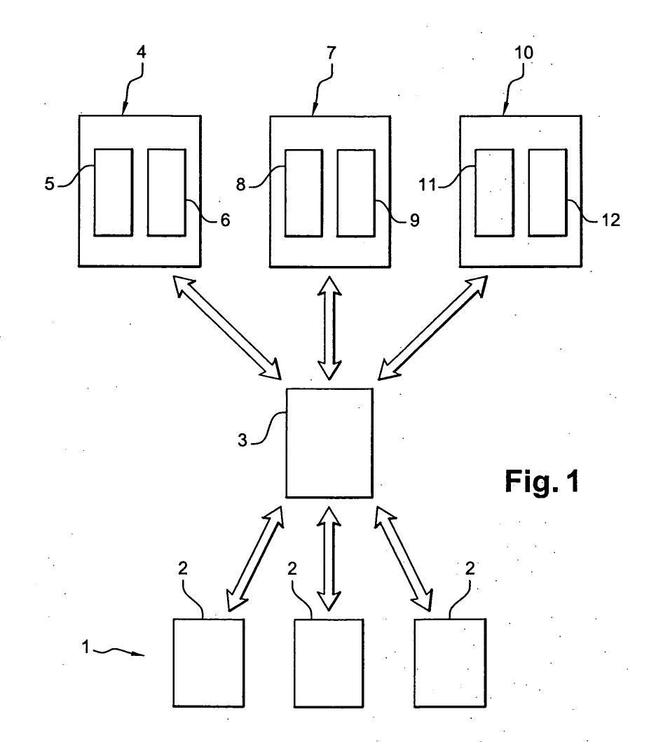

FIG. 1 schematically shows different elements interacting with the downloading means 1 in the form of a downloading terminal 2.

The central unit of the terminal as well as its associated peripherals are advantageously managed by an operating system of the Microsoft Windows (Registered Trademark) type.

An Internet navigator is used on the terminal 2, adapted to operate the features of the Internet Explorer application present in the Microsoft Windows (Registered Trademark) operating system, this Internet navigator advantageously being secured.

In order to allow access to a greater number of people, the terminals 2 according to the invention are located in a public place.

The process according to the invention is based on the exchange of data from the terminal 2 and, more precisely, on the purchase and downloading of song titles or video clips onto a downloading support or personal storage means such as a USB card or key, a personal digital assistant (PDA), a pocket computer or PALM, SMARTPHONE (Registered Trademark), POCKET PC (Registered Trademark), a laptop computer or a personal digital stereo, for example, the terminal 2 presenting a set of appropriate connectors for connecting these personal storage means to the terminal 2.

It is thus possible, thanks to the process according to the invention, to purchase musical titles in public places, at advantageous prices and to download them onto a storage support or personal storage means.

Downloading takes place from an Internet site selling one or more titles on-line.

The process according to the invention therefore comprises the step of downloading music titles from a terminal located in a public place.

To that end, it is possible to provide a monthly or annual subscription for downloading a predetermined quantity of titles.

The downloading of the data is paid for either with the aid of a bank card or a prepaid card that may be directly purchased from a trader, or purchased on Internet at a defined public price.

To that end, the terminal is connected to a bank card or prepaid card reader of type known per se.

Earphones, of type known per se, are also provided, to allow the user to listen to the titles that he/she might download.

Additionally, the user may view video clips that he/she might download.

The terminals 2 according to the invention are connected individually and collectively to at least one proxy server 3, of type known per se.

The function of the proxy server 3 is to serve as intermediary between the terminals 2 and the outside servers, particularly the broadcasting servers.

More precisely, the proxy server 3 according to the invention is connected to a payment server 4 constituted by a bank card payment server 5 and a prepaid card payment server 6.

The proxy server 3 also comprises an FTP server, of type known per se, adapted to download data from a broadcasting server 7 constituted by a data licence managing server 8 and a data storage server 9.

The data licence managing server 8 issues licences on the data with a secured and encrypted access and the data storage server issues the protected titles.

The proxy server 3 also comprises a dedicated server 10 constituted by an e-mail managing server 11 and an http server 12.

The downloaded and exchanged data are advantageously musical works in digital form.

The principal functions of the proxy server 3 are as follows:
as firewall, as the information relative to the payment transits via the proxy server 3;
To memorize the data most frequently downloaded;
To memorize the pages of the navigation interface.

In this way, the process of data downloading which will be explained hereinbelow is optimized by rendering the dimensions of the network minimum.

In order to solve the problem associated with the spread and tracking of the plurality of downloading terminals 2, the navigation interface, accessible from the terminal 2, is not housed locally on the terminal 2 but on the remote dedicated web http server 12, accessible via a network of the VPN type by the navigator, the interface being found on the http server 12 and a copy of the interface on the proxy server 3.

The user of the terminal 2 accesses the interface on the proxy server 3 which regularly updates the interface from the http server 12.

In this way, any modification made on the interface from the http server 12 is passed onto all the terminals 2 connected to the proxy server 3.

The navigation interface is advantageously developed by means of the compiler of the Flash (Registered Trademark) type.

The navigator advantageously allows the user to navigate on the interface housed by the http server 12 but prevents access to the files housed locally by the terminal 2 and in the desktop of Microsoft Windows (Registered Trademark).

In this way, the problems of security and integrity of the system raised by the implantation of the terminals 2 is public places are solved.

Moreover, in order to secure all the exchanges of data between the different servers and the terminal 2, the exchanges take place via Internet by means of a secured connection of the Virtual Private Network (VPN) type.

Routers of CISCO type ensure the establishment of the connections to the VPN network.

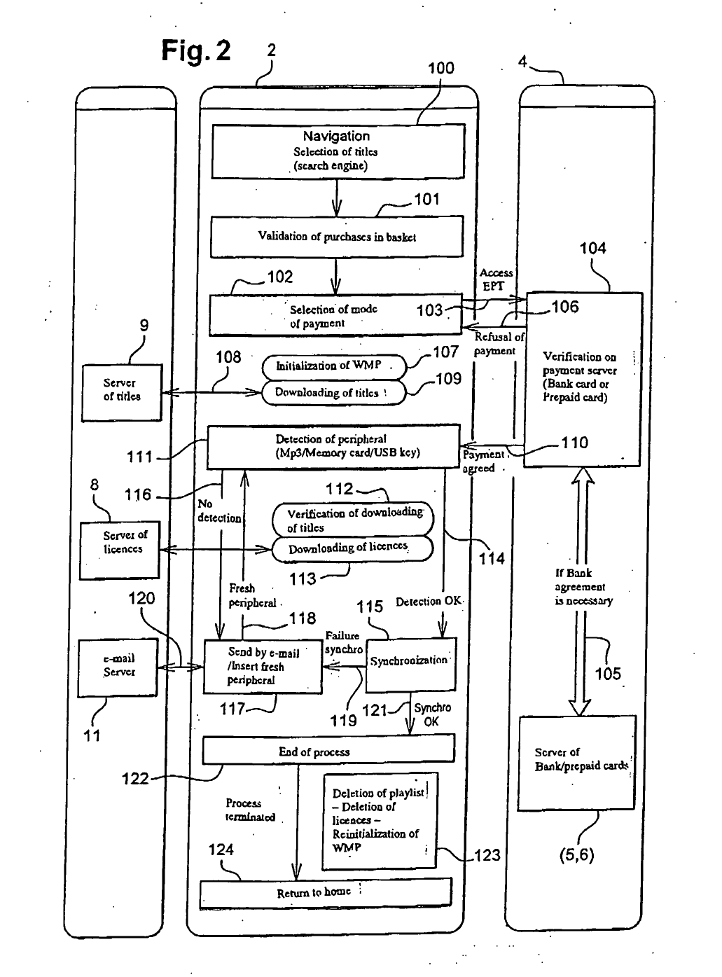

FIG. 2 schematically shows the steps of the process of downloading according to the invention.

The user of the terminal 2 according to the invention must firstly navigate on the navigation interface accessible from the terminal 2 and select the data or musical titles that he/she wishes to download (step 100).

The downloaded data are then stored temporarily in a basket, the user then being able either to add titles to the basket or remove some therefrom, or check the contents of his/her basket.

Once the user has chosen all the titles to be downloaded, he/she must then validate the titles contained in the basket (step 101).

He/she must then proceed with the payment of the titles to be downloaded, firstly choosing the mode of payment (step 102), i.e. paying either by bank card or by prepaid card.

Moreover, in parallel, when the basket is being validated (step 101), the Windows Media Player (WMP) 10.0 (Registered Trademark) software, present on the terminal 2, is initialized.

This operation of initialization is effected on a so-called Digital Right Management (DRM) module, the DRM technology being a process consisting in associating with a multimedia file, exclusively readable by one type of reading software, information indicating to the machine used for its storage whether the user in fact benefits from the listening and reproduction rights of the multimedia file.

The DRM module according to the invention has advantageously been written in the language C++ and programmatically accesses the services offered by Windows Media Player (Registered Trademark), by manipulating the methods offered by the Windows Media SDK Components (Registered Trademark) development kit.

It goes without saying that the process according to the invention is also applicable to any type of software performing the same functions as the WMP software and on any type of version of WMP, even if the described version of the process uses more particularly the version 10.0 of the Windows Media Player (Registered Trademark) software. One version of the invention offers: the programmatic control of the reader, the synchronization and pre-listening of the titles in continuous flow. The process of the invention might be transposed to other types of readers. In that case, only the standards of programmation would be capable of changing, the algorithm remaining substantially the same.

During the step 102 of selecting the mode of payment, the user must choose whether to pay by bank card or by prepaid card.

The user then accesses the Electronic Payment Terminal (EPT) (step 103) after having inserted his/her bank card or prepaid card, and then possibly enters a secret code on a bank card reading terminal connected to a numbered keyboard, of type known per se.

The proxy server 3 is then connected to the bank server 4 to check whether the user has access to the bank card payment server 5 or to the prepaid card payment server 6 (step 104).

If a bank agreement is necessary, then a direct connection is established on the bank card payment server 5. If a bank agreement is not necessary, the connection is established on the prepaid card payment server 6 (step 105).

If the payment is refused (step 106), for example due to lack of credit on the prepaid card, then the user has several possibilities: either of using a fresh mode of payment, or of recommencing the operation, or of stopping navigation on the terminal 2.

The process of payment is therefore of the type currently used with traders and therefore corresponds to a dialogue between the terminal 2, on which the user is navigating, and the payment server 4 via the proxy server 3. It should be noted that, in the case of payment by prepaid card, the bank servers do not intervene.

The terminal 2 is advantageously connected to the payment server 4 by the proxy server 3, i.e. by an IP address and not by an RS232 connection.

Furthermore, during validation of the selection to be placed in the basket (step 101), the terminal 3 has initialized Windows Media Player WMP (step 107) with the aid of the DRM module.

Similarly, during this same validation step 101, the terminal 2 is connected, via the proxy server 3 to the broadcasting server 7, and more precisely to the digital title storage server 9 (step 108), and this only in the event of the title not being found on the proxy server.

The data validated in the basket during step 101 are thus downloaded on the proxy server 4 (step 109) with the aid of the DRM module of the terminal 3.

Once the agreement of payment has been obtained from the payment server 4 (step 1 10), the user is then invited to insert his/her downloading support in the corresponding port, the terminal then attempting to detect the downloading support (step 111).

It has been seen hereinbefore to what a downloading support or personal storage means could correspond.

Once the payment has been accepted, the DRM module verifies whether the ordered data have indeed been downloaded (step 112).

In the case of a positive response, the DRM module downloads the corresponding licences (step 113) from the licence managing server 8.

During the step of detection of the storage peripheral (step 111), if the terminal 3, and more precisely its DRM module, detects the storage peripheral (step 114), then the DRM module starts the step of synchronization of the downloaded titles (step 115), i.e. a list of titles is created and transferred onto the storage peripheral.

More precisely, the synchronization step 115 consists in copying multimedia files protected by a DRM onto a portable storage and reading peripheral, while associating therewith the rights that the user enjoys on the consultation and reproduction of the work.

In addition, the DRM module of the terminal 3, after having downloaded the titles (step 109) and the licences (step 113), definitively deletes the titles and licences having transited through the terminal 3, so that the latter is protected against piracy.

In the event of non-detection by the terminal 3 of a storage peripheral (step 116) or in the event of failure of synchronization step 115 (step 119), it is proposed to the user either to insert a fresh storage peripheral or to send the downloaded titles by e-mail, in which case the user must enter an e-mail address (step 117), and an e-mail is sent to that address via the e-mail managing server (step 120), the e-mail sent advantageously containing a downloading link with an access code.

If the user inserts a fresh peripheral (step 118), then the peripheral detection step (step 111) is recommenced.

If the synchronization step 115 continues to its end (step 121), then the process of downloading is terminated (step 122), the DRM module deletes the list of downloaded titles (Playlist) and the licences and re-initializes WMP (step 123), and the terminal 3 proposes the home menu to the user (step 124).

The process advantageously comprises the steps of:
Selection of the data to be downloaded,
Validation of the customer's selection,
Insertion of the downloading support and selection of the downloading support and/or its model,
Connection of the downloading support with the terminal,
Detection of the downloading support by the terminal,
Payment of the downloaded data by the customer,
Transfer of the data towards the downloading support.

The present invention therefore consists in a process of downloading making it possible for a user, from a downloading terminal located in a public place, to:
search interactively for musical or audio-visual works from an available catalogue;
consult and obtain in situ a partial summary of the complementary information on these works, particularly on their authors;
download the selected works towards any type of removable storage peripheral currently available on the market, in the form of digital files allowing a limited number of subsequent reproductions, and thus avoiding, as much as possible, contributing to piracy.
pay the price of reproduction of the work and the licence, by secured means of payment.

Moreover, when the downloading terminal 2 is inactive, a screen saver displaying advertisements is provided.

“Public place” is understood in this specification to mean any place freely accessible to any person, particularly without restriction or paid entry, such places or zones being intended for commercial purposes or activities, for example stores, supermarkets, railroad stations, airports, ports, etc. . . .

What is claimed is:

1. Process for downloading data from Internet onto a data storage support from a downloading terminal,
wherein said data are downloaded directly by connection of said support on said terminal, which is stationary and located in a public place.

2. The process of claim 1, wherein the downloading is effected via a proxy server and a payment server.

3. The process of claim 1 or 2, wherein it comprises the steps of:
Selection of the data to be downloaded,
Validation of the customer's selection,
Selection of the support for downloading and/or its model,
Insertion of the downloading support and connection of the downloading support with the terminal,
Detection of the downloading support by the terminal,
Payment of the downloaded data by the customer,
Transfer of the data towards the downloading support.

4. The process of one of the preceding claims, wherein said downloaded data are music titles.

5. The process of one of claims 3 or 4, wherein said downloading support is a USB key, a PDA, a pocket computer or PALM, SMARTPHONE (Registered Trademark), POCKET PC (Registered Trademark), a laptop computer or a personal digital stereo.

6. The process of one of the preceding claims, wherein it is implemented from a proxy server comprising a payment server, a data-storage server, an e-mail managing server, an http server and an FTP server, and, in addition, from a broadcasting server comprising a storage server and a server for managing the licences associated with the data.

7. The process of one of the preceding claims, wherein the downloaded data are paid for either with a bank card or with a prepaid card.

8. The process of claim 8, wherein a Digital Right Management (DRM) module is associated with the operating system of said terminal.

9. The process of claim 8, wherein said DRM module is adapted to download said data from said storage server onto said proxy server and the licenses from said licence managing server.

10. Device for carrying out the process of one of the preceding claims, making it possible to download data from Internet onto a data storage support from a downloading terminal, comprising means for connection of said support on said terminal, which is stationary and located in a public place, a proxy server and a payment server.
